(19) United States
(12) Patent Application Publication
(10) Pub. No.: US 2024/0377355 A1
(43) Pub. Date: Nov. 14, 2024

(54) APPARATUS TO MEASURE ELECTROPHORETIC MOBILITY

(71) Applicant: Wyatt Technology, LLC, Goleta, CA (US)

(72) Inventors: Steven P. Trainoff, Santa Barbara, CA (US); David Rahmlow, Goleta, CA (US)

(21) Appl. No.: 18/660,505

(22) Filed: May 10, 2024

Related U.S. Application Data
(60) Provisional application No. 63/466,211, filed on May 12, 2023.

(51) Int. Cl. G01N 27/447

(52) U.S. Cl. CPC G01N 27/44721; G01N 27/44743

(57) ABSTRACT

Described are examples of an apparatus for measuring electrophoretic mobility. The apparatus is configured as an optical interferometer wherein a sample to be analyzed in placed on one arm of the interferometer. Polarization-maintaining optical fibers and optical components maintain polarization stability and performance of the interferometer. Rayleigh scattered light from the sample is combined with light from the reference arm of the interferometer. The scattered light is shifted in frequency with a corresponding signal having a magnitude that is proportional to the velocity of the particles in solution. Particle velocity is a function of solvent viscosity, particle size, applied field strength, and electric charge. Measurement of electrophoretic mobility and particle size can be used to calculate the electric charge of the particles.

### RELATED APPLICATION

This application claims the benefit of the earlier filing date of U.S. Provisional Patent Application Ser. No. 63/466,211, filed May 12, 2023 and titled “Apparatus to Measure Electrophoretic Mobility,” the entirety of which is incorporated herein by reference.

### FIELD OF THE INVENTION

The present disclosure relates to electrophoretic mobility, and more specifically, to an apparatus to measure electrophoretic mobility.

### SUMMARY

In an exemplary embodiment, the apparatus includes (1) a long coherence length laser, (2) a fiber splitter optically coupled to the laser, (3) a first polarization maintaining acousto-optic modulator (AOM) optically coupled to a reference arm output of the splitter, (4) a second polarization maintaining acousto-optic modulator optically coupled to an output of the first modulator, (5) a polarization maintaining attenuator optically coupled to an output of the second modulator, (6) a sample cell to contain a sample and optically coupled to a sample arm output of the splitter, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample.

In an exemplary embodiment, the apparatus includes (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5) a sample cell optically to contain a sample and optically coupled to a sample arm output of the splitter, (6) a sample arm polarization maintaining acousto-optic modulator optically coupled to an output of the sample cell, (7) a polarization maintaining combiner optically coupled to an output of the attenuator and to an output of the sample arm modulator, and (8) a photo detector to detect light output from the combiner and to output a time-varying intensity signal, I, to be analyzed for shifts in frequency in the time-varying intensity signal to measure electrophoretic mobility in the sample.

In an exemplary embodiment, the apparatus includes (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5)) a sample arm polarization maintaining acousto-optic modulator optically coupled to a sample arm output of the splitter, (6) a sample cell to contain a sample and optically coupled to the output of the sample arm modulator, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample.

### BRIEF DESCRIPTION OF THE DRAWINGS

Advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A and FIG. 1B are schematic diagrams of embodiments of an apparatus for measuring electrophoretic mobility in which the embodiments include an interferometric configuration with a serial arrangement of AOMs in a reference arm.

FIG. 2A and FIG. 2B are schematic diagrams of embodiments of an apparatus for measuring electrophoretic mobility in which the embodiments have an interferometric configuration with a parallel arrangement of AOMs in which one AOM is in a reference arm and the other AOM is in a sample arm.

FIG. 3 is a schematic diagram of an embodiment of an apparatus for measuring electrophoretic mobility and shows an interferometric configuration with a parallel arrangement of AOMs in which one AOM is in a reference arm and the other AOM is in a sample arm.

FIG. 4 is a graphical depiction of the power spectrum output for a single AOM apparatus and a power spectrum output for an embodiment of a dual AOM apparatus, as described herein.

FIG. 5 depicts how each fiber connector in an apparatus can mix the polarization states of incident light.

### DETAILED DESCRIPTION

The present disclosure describes an apparatus to measure electrophoretic mobility. The preparation of materials in solution often requires that the particles remain in suspension and not aggregate. The electrophoretic mobility indicates the electric charge of these particles, which is indicative of the stability of the material in solution.

In this apparatus, the sample to be analyzed is placed in one arm of an optical interferometer. The interferometer combines Rayleigh scattered light from the sample with light from the “reference” arm of the interferometer. The scattered light is shifted in frequency relative to the original laser light due to the Doppler effect. The magnitude of this frequency shift is proportional to the velocity of the particles in solution and is typically of the scale of microns per second. In the absence of an external field, the particle motion is random Brownian motion and the frequency distribution of the scattered light is broadened but with no net shift in frequency. This is the principle behind Dynamic Light Scattering and is used to determine particle size. The application of an external electric field to the sample results in a net velocity as the particles are driven towards one electrode. This velocity is a function of solvent viscosity, particle size, applied field strength, and electric charge. Therefore, a measurement of electrophoretic mobility (velocity/applied field strength) and particle size can be used to calculate the electric charge of the particles.

The Doppler shift of the scattered light is measured using the optical interferometer. The interference of reference and scattered light gives rise to a beat frequency:

$$I ( t ) = {I}_{ref} + {I}_{sca} + \sqrt{{I}_{ref} {I}_{sca}} cos δ t$$

where δ is the Doppler shift frequency imparted to the scattered light. This leads to the experimental problems. First, the Doppler shift δ is typically on the scale of 1-100 Hz, where 1/f noise leads to high noise baselines. In addition, positive and negative shifts cannot be distinguished (as cos δt=cos−δt). Imparting an overall frequency shift to the reference or sample paths in the interferometer overcomes these issues. If the reference path is shifted in frequency by Δ, then the signal becomes:

$$I ( t ) = {I}_{ref} + {I}_{sca} + \sqrt{{I}_{ref} {I}_{sca}} cos ( Δ + δ ) t$$

The overall beat frequency is shifted away from f=0, and the effects of positive and negative charge can be distinguished.

Prior implementations for measuring electrophoretic mobility typically utilize free-spaced optics and use phase modulators with limited range to generate the frequency shift Δ. The use of free-space optics impacts the reliability and serviceability of the measurement instrument. Free-space optical components often become misaligned, particularly during shipment of the instrument. Replacing individual components is also complex, as the entire optical bench requires realignment. The use of phase modulators with limited range (such as piezo-scanned mirrors) limits the duration of any given measurement. The frequency resolution of the instrument is inversely proportional to the measurement duration; a longer measurement allows for finer frequency resolution, and therefore, a more precise measurement of electrophoretic mobility.

In various embodiments of an apparatus for measuring electrophoretic mobility in accordance with the principles disclosed herein, the light source is a long coherence length laser. The laser may operate using a single longitudinal mode. A “long” coherence length means that the coherence length of the laser exceeds the path length difference between the reference and sample arms of the interferometer:

$${L}_{c} = \frac{{λ}^{2}}{2 π Δλ}$$

where L_{c} is the coherence length, λ is the laser wavelength, and Δλ is the laser linewidth. In some implementations, 5 meters<L_{c} is adequate. The light is coupled into a single-mode, polarization-maintaining optical fiber. Preferably, all fibers are polarization-preserving because an interference signal only arises for light mixed with the same polarization. If the polarization state is lost, then the beat amplitude is diminished or unstable. The light is split into the reference and sample interferometer paths. Preferably, most of the light is sent to the sample arm, as only a small fraction (typically 10⁻⁵ to 10⁻³) of the light incident on the sample is scattered. Typically a split fraction of 85%-95% in the sample arm is desirable. Fiber splitters with a larger split ratio (99%) are available, but usually have lower intensity stability.

In a parallel AOM arrangement, such as shown in Error! Reference source not found. below, the reference and sample arms of the interferometer each contain one AOM. For the sample arm, the AOM may be placed before or after the sample cell. It is usually preferable to dispose the AOM after the sample cell, as the optical power loss in the AOMs is typically about 50%. By placing the AOM after the sample cell, any other concurrent measurements on the sample see a loss in light intensity. The reference path also contains an AOM. The interferometer paths are recombined with a second fiber splitter, and the light is measured using a photodetector. The signal at the photodetector is then:

$$I ( t ) = {I}_{ref} + {I}_{sca} + \sqrt{{I}_{ref} {I}_{sca}} cos ( {Δ}_{1} + δ - {Δ}_{2} ) t$$

where Δ₁ is the drive frequency of the AOM in the sample path, and Δ₂ is the drive frequency of the AOM in the reference path. The AOM drive frequencies are chosen such that δ<<|Δ₁−Δ₂|<<Δ₁, Δ₂ is in a convenient range for measurement, typically 5-50 kHz. The choice of Δ₁, Δ₂ is determined by the available AOM technology and is typically 50-250 MHz. In this case, the AOMs are chosen so that both AOMs are of positive or negative order (+1 or −1 diffraction order).

Serial AOM embodiments, as shown for example in Error! Reference source not found. below, are similar to the parallel embodiment, except that both AOMs are placed in the reference path. In this case,

$$I ( t ) = {I}_{ref} + {I}_{sca} + \sqrt{{I}_{ref} {I}_{sca}} cos ( {Δ}_{1} + {Δ}_{2} - δ ) t$$

The two AOMs are selected to have opposite order (+1 and −1 diffraction order) so that |Δ₁+Δ₂|<<Δ₁, Δ₂ is in a range convenient for measurement.

For either parallel or serial embodiments, the “reference” and “scattering” intensities I_{ref}, I_{sca} should be: (intensities in either arm)
1. Stable: I_{ref} should be stable over time. The intensity of I_{sca} may vary over time due to Brownian motion in the sample.
2. Symmetric: I_{ref}>>I_{sca} ensures that the beat signal is a symmetric intensity modulation.
3. Non-saturating: I_{ref}<Imax keeps the signal from saturating the photodetector.

Additional optical elements may be utilized to ensure that these conditions are satisfied. An optical attenuator in the reference path allows I_{ref} to be optimized for the photodetector. An optical attenuator or shutter in the sample path allows direct testing of I_{ref} as a diagnostic and can enable measurement of highly scattering samples.

Only light components of the same polarization results in optical interference, and hence a beat signal, at the photodetector. Therefore, it is necessary to maintain polarization throughout the interferometer. In addition to the use of polarization-maintaining fiber, it is also preferable to control the polarization orientation of all optical components. A mismatch in coupling two fibers, for example, results in a mixing of polarization states. Within the interferometer, each additional mixing of polarization can interfere constructively or destructively. If unmanaged, large, uncontrolled variations in the output power in the desired polarization state can occur. To address this possibility, one or more optical polarizers may be placed between the optical elements. By removing any remnants of the wrong polarization, polarization losses cannot interfere constructively and the amplitude of intensity variations is reduced.

In an exemplary embodiment, the apparatus includes (1) a long coherence length laser, (2) a fiber splitter optically coupled to the laser, (3) a first polarization maintaining acousto-optic modulator (AOM) optically coupled to a reference arm output of the splitter, (4) a second polarization maintaining acousto-optic modulator optically coupled to an output of the first modulator, (5) a polarization maintaining attenuator optically coupled to an output of the second modulator, (6) a sample cell to contain a sample and optically coupled to a sample arm output of the splitter, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample. In an embodiment, the laser is a single frequency and polarized laser. In an embodiment, the splitter provides for the efficient use of laser light from the ratio by having an asymmetric split ratio. In an embodiment, the AOM receives light and shifts the frequency, f, of the light, while leaking some light that maintained its original frequency. In an embodiment, the attenuator controls power levels of the photo detector. In an embodiment, the photo detector is a silicon photodiode, an avalanche photodiode or a photomultiplier tube. In an embodiment, the apparatus is a series dual-AOM system that allows more light into the sample cell, for applications such as DLS or SLS.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometers to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is an SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, that is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

### Series Dual-AOM

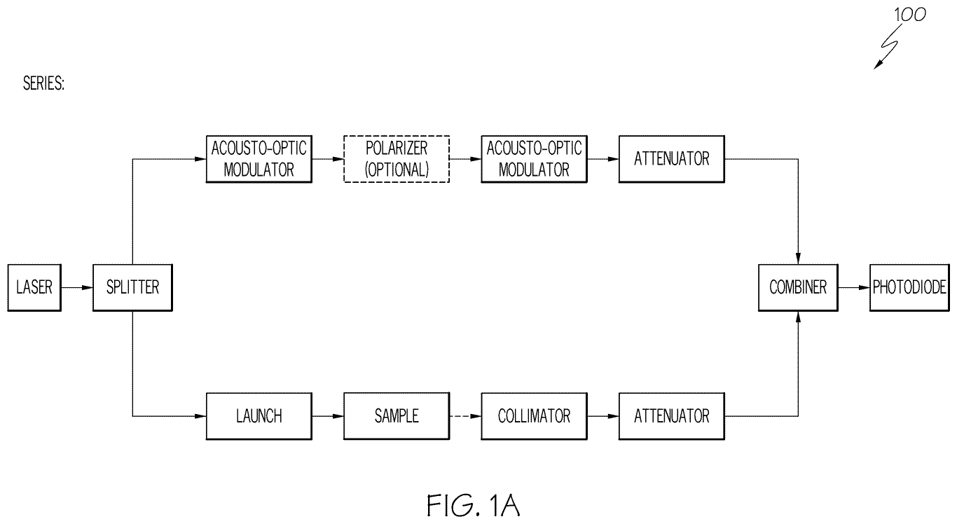

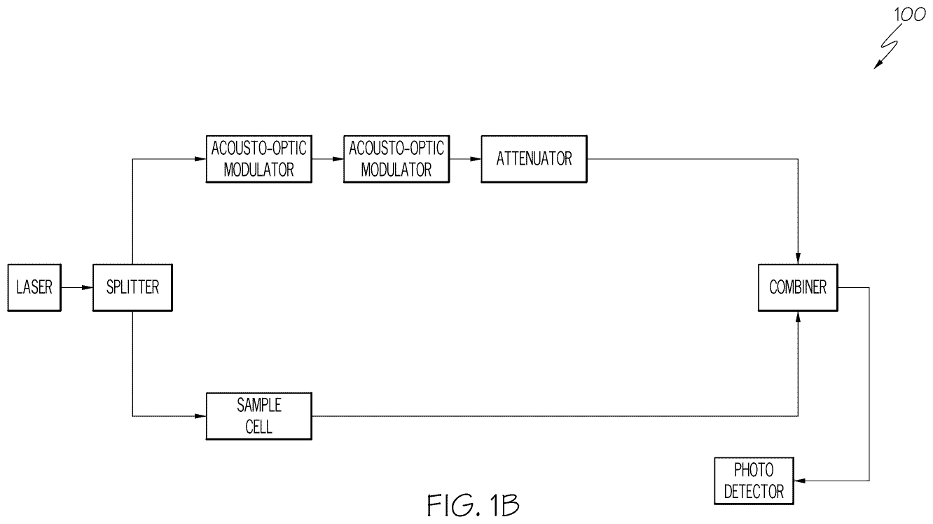

In an embodiment, FIG. 1A and FIG. 1B depict the apparatus including (1) a long coherence length laser, (2) a fiber splitter optically coupled to the laser, (3) a first polarization maintaining acousto-optic modulator (AOM) optically coupled to a reference arm output of the splitter, (4) a second polarization maintaining acousto-optic modulator optically coupled to an output of the first modulator, (5) a polarization maintaining attenuator optically coupled to an output of the second modulator, (6) a sample cell to contain a sample and optically coupled to a sample arm output of the splitter, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample. In a further embodiment, the apparatus further includes at least one polarization maintaining (PM) fiber coupling any of the laser, the splitter, the modulators, the attenuator, the sample cell, and the combiner together. For example, the PM fiber is a standard coupling (e.g., a FCP coupling). In an embodiment, any of the splitter, the modulators, the attenuator, and the combiner are fused together, where such fused components could result in better performance of the apparatus.

In an embodiment, the splitter includes a split ratio where a majority of the laser light is directed to the sample cell. For example, the split ration could be such that 50%-99.1% of the light is directed to the sample cell (e.g., 96:4 split ration with 96% of the light directed to the sample cell and 4% of the light directed to reference arm). In an embodiment, the sample cell includes a shutter between a cell enclosure and a collimator. In a further embodiment, the apparatus further includes at least one polarizer optically coupled between any of the splitter, the modulators, the attenuator, and the combiner (e.g., between the 2 AOMs) (e.g., fiber coupling), to prevent polarization cross-talk among the optical components. In an embodiment, at least one of the modulators (AOMs) includes a polarizer. In an embodiment, the laser includes an optical fiber launch to couple light to the splitter.

### Parallel Dual-AOM

In an exemplary embodiment, the apparatus includes (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5) a sample cell to contain a sample and optically coupled to a sample arm output of the splitter, (6) a sample arm polarization maintaining acousto-optic modulator optically coupled to an output of the sample cell, (7) a polarization maintaining combiner optically coupled to an output of the attenuator and to an output of the sample arm modulator, and (8) a photo detector to detect light output from the combiner and to output a time-varying intensity signal, I, to be analyzed for shifts in frequency in the time-varying intensity signal to measure electrophoretic mobility in the sample. In an embodiment, the laser is a single frequency and polarized laser. In an embodiment, the splitter provides for the efficient use of laser light from the ratio by having an asymmetric split ratio. In an embodiment, the AOM receives light and shifts the frequency, f, of the light, while leaking some light that maintained its original frequency. In an embodiment, the attenuator controls power levels of the photo detector. In an embodiment, the photo detector is a silicon photodiode, an avalanche photodiode or a photomultiplier tube. In an embodiment, the apparatus is a parallel dual-AOM system that could avoid optical non-ideal behavior that leads to zero order leakage in the AOM (an artifact), with only of the arms having such a defect, resulting in higher quality intensity, I, data.

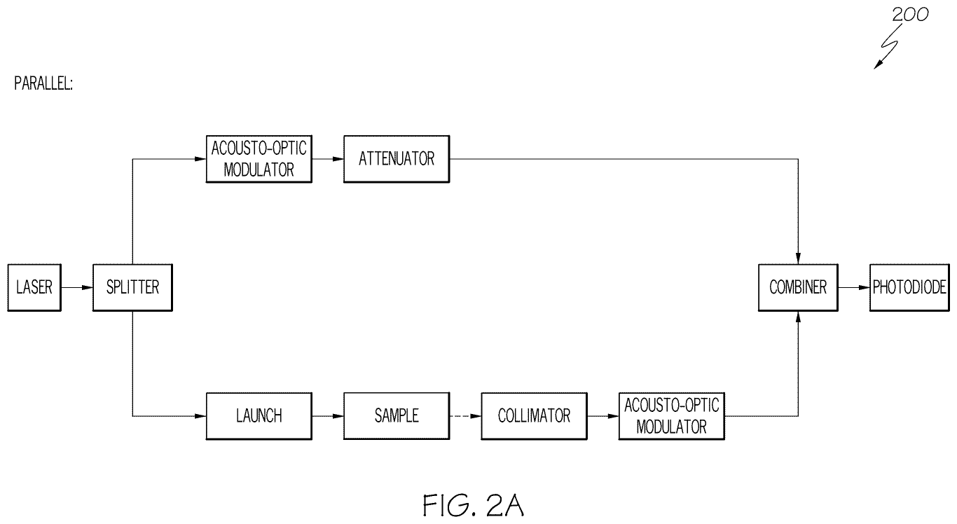

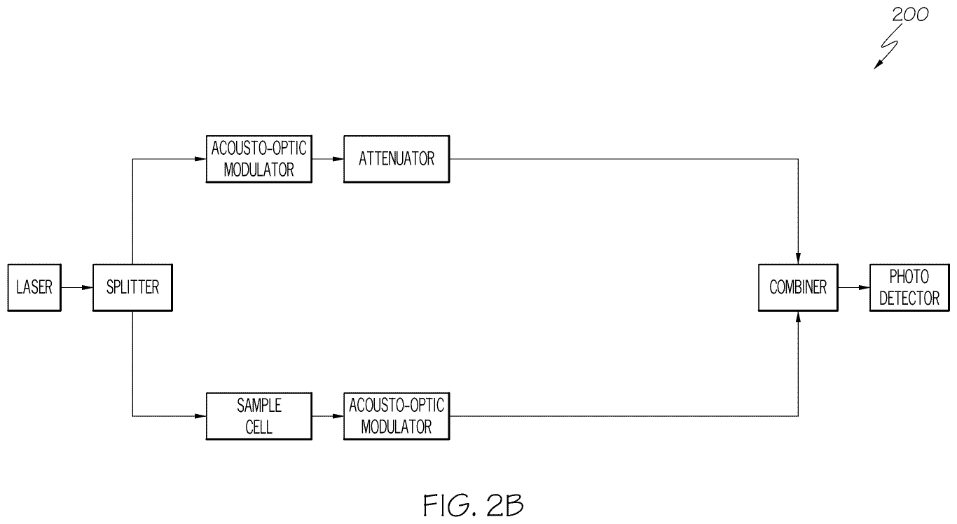

In an embodiment, FIG. 2A and FIG. 2B depict the apparatus including (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5) a sample cell to contain a sample and optically coupled to a sample arm output of the splitter, (6) a sample arm polarization maintaining acousto-optic modulator optically coupled to an output of the sample cell, (7) a polarization maintaining combiner optically coupled to an output of the attenuator and to an output of the sample arm modulator, and (8) a photo detector to detect light output from the combiner and to output a time-varying intensity signal, I, to be analyzed for shifts in frequency in the time-varying intensity signal to measure electrophoretic mobility in the sample. In a further embodiment, the apparatus further includes at least one polarization maintaining (PM) fiber coupling any of the laser, the splitter, the modulators, the attenuator, the sample cell, and the combiner together. For example, the PM fiber is a standard coupling (e.g., a FCP coupling). In an embodiment, any of the splitter, the modulators, the attenuator, and the combiner are fused together, where such fused components could result in better performance of the apparatus.

In an embodiment, the splitter includes a split ratio where a majority of the laser light is directed to the sample cell. For example, the split ration could be such that 50%-99.1% of the light is directed to the sample cell (e.g., 96:4 split ration with 96% of the light directed to the sample cell and 4% of the light directed to reference arm).

In an exemplary embodiment, the apparatus includes (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5)) a sample arm polarization maintaining acousto-optic modulator optically coupled to a sample arm output of the splitter, (6) a sample cell to contain a sample and optically coupled to the output of the sample arm modulator, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample. In an embodiment, the laser is a single frequency and polarized laser. In an embodiment, the splitter provides for the efficient use of laser light from the ratio by having an asymmetric split ratio. In an embodiment, the AOM receives light and shifts the frequency, f, of the light, while leaking some light that maintained its original frequency. In an embodiment, the attenuator controls power levels of the photo detector. In an embodiment, the photo detector is a silicon photodiode, an avalanche photodiode or a photomultiplier tube. In an embodiment, the apparatus is a parallel dual-AOM system that could avoid optical non-ideal behavior that leads to zero order leakage in the AOM (an artifact), with only of the arms having such a defect, resulting in higher quality intensity, I, data.

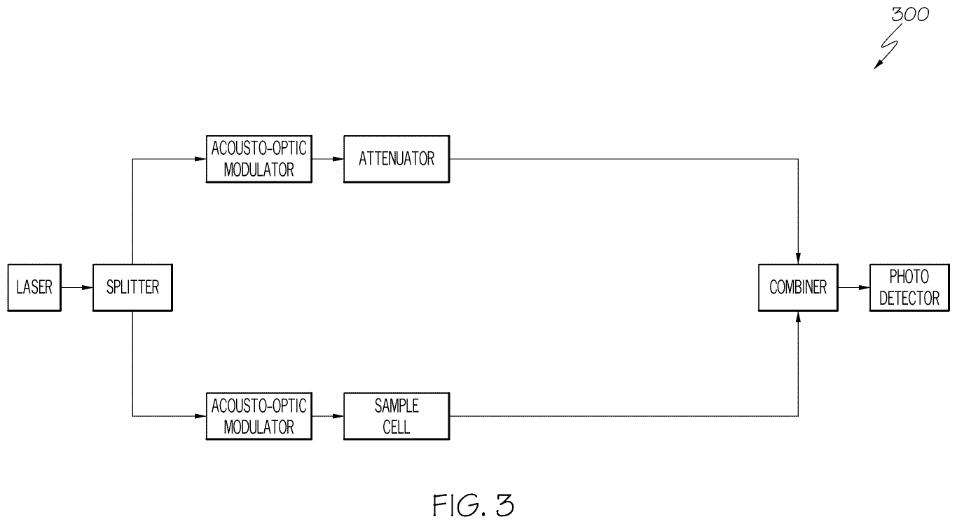

In an embodiment, FIG. 3 depicts the apparatus including (1) a long coherence length laser, (2) a fiber splitter optically coupled to the laser, (3) a reference arm polarization maintaining acousto-optic modulator (AOM) optically coupled to a reference arm output of the splitter, (4) a polarization maintaining attenuator optically coupled to an output of the reference arm modulator, (5)) a sample arm polarization maintaining acousto-optic modulator optically coupled to a sample arm output of the splitter, (6) a sample cell to contain a sample and optically coupled to the output of the sample arm modulator, (7) a polarization maintaining combiner optically coupled to an output of the attenuator and to an output of the sample cell, and (8) a photo detector to detect light output from the combiner and to output a time-varying intensity signal, I, to be analyzed for shifts in frequency in the time-varying intensity signal to measure electrophoretic mobility in the sample. In a further embodiment, the apparatus further includes at least one polarization maintaining (PM) fiber coupling any of the laser, the splitter, the modulators, the attenuator, the sample cell, and the combiner together. For example, the PM fiber is a standard coupling (e.g., a FCP coupling). In an embodiment, any of the splitter, the modulators, the attenuator, and the combiner are fused together, where such fused components could result in better performance of the apparatus.

In an embodiment, the splitter includes a split ratio where a majority of the laser light is directed to the sample cell. For example, the split ration could be such that 50%-99.1% of the light is directed to the sample cell (e.g., 96:4 split ration with 96% of the light directed to the sample cell and 4% of the light directed to reference arm).

### EXAMPLE

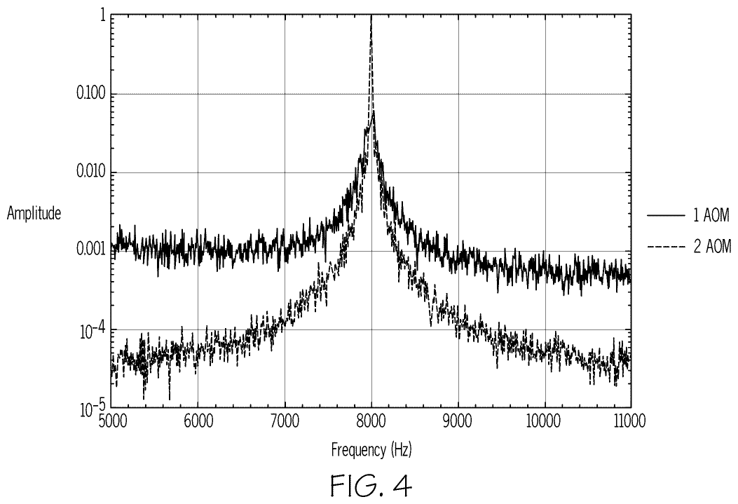

For example, FIG. 4 depicts the power spectrum output a single AOM apparatus versus the power spectrum output a dual AOM apparatus, as described in the present disclosure. FIG. 4 shows that the dual AOM apparatus could achieve a lower and flatter noise floor (improved noise performance), through the use of audio-frequency electronics, and thus could achieve higher sensitivity in the intensity data.

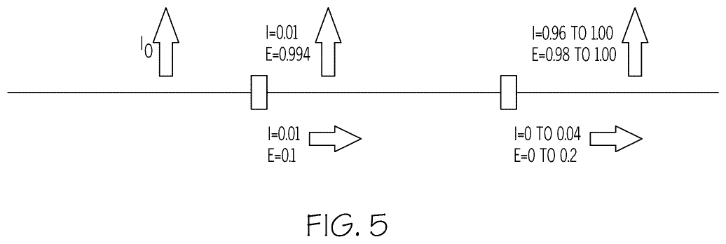

In another example, FIG. 5 depicts that each fiber connector in the apparatus could “mix” the polarization states of the incident light. If the apparatus were to have multiple connectors, then the light in each state could mix constructively or destructively in an uncontrolled manner, resulting in large intensity variations in the output intensity, I, of the desired polarization if such mixing were not controlled.

While numerous embodiments have been shown and described above, the description is intended to be exemplary, rather than limiting and it should be understood by those of ordinary skill in the art that various changes in form and detail may be made therein without departing from the scope of the invention as recited in the accompanying claims. For example, the polarization-maintaining optical fibers may be replaced, at least in part, with polarizing optical fibers. In another example, one AOM may operate with a positive frequency shift, one AOM may operate with negative frequency shift and, preferably, the +1 and −1 order diffractions are utilized from the two AOMs. Alternatively, both AOMS may operate with a positive frequency shift or both AOMs may operate with a negative frequency shift.

What is claimed is:

1. An apparatus comprising:
a long coherence length laser;
a fiber splitter optically coupled to the laser;
a first polarization maintaining acousto-optic modulator optically coupled to a reference arm output of the splitter;
a second polarization maintaining acousto-optic modulator optically coupled to an output of the first modulator;
a polarization maintaining attenuator optically coupled to an output of the second modulator;
a sample cell to contain a sample and optically coupled to a sample arm output of the
splitter;
a polarization maintaining combiner optically coupled to an output of the attenuator and to an output of the sample cell; and
a photo detector to detect light output from the combiner and to output a time-varying intensity signal, I, to be analyzed for shifts in frequency in the time-varying intensity signal to measure electrophoretic mobility in the sample.

2. The apparatus of claim 1 further comprising at least one polarization maintaining fiber coupling any of the laser, the splitter, the modulators, the attenuator, the sample cell, and the combiner together.

3. The apparatus of claim 1 wherein any of the splitter, the modulators, the attenuator, and the combiner are fused together.

4. The apparatus of claim 1 wherein the splitter comprises a split ratio wherein a majority of the laser light is directed to the sample cell.

5. The apparatus of claim 1 wherein the sample cell comprises a shutter between a cell enclosure and a collimator.

6. The apparatus of claim 1 further comprising at least one polarizer optically coupled between any of the splitter, the modulators, the attenuator, and the combiner.

7. The apparatus of claim 1 wherein at least one of the modulators comprises a polarizer.

8. The apparatus of claim 1 wherein the laser comprises an optical fiber launch to couple light to the splitter.

9. An apparatus comprising:
a long coherence length laser;
a fiber splitter optically coupled to the laser;
a reference arm polarization maintaining acousto-optic modulator optically coupled to a reference arm output of the splitter;
a polarization maintaining attenuator optically coupled to an output of the reference arm modulator;
a sample cell to contain a sample and optically coupled to a sample arm output of the splitter;
a sample arm polarization maintaining acousto-optic modulator optically coupled to an output of the sample cell;
a polarization maintaining combiner optically coupled to an output of the attenuator and to an output of the sample arm modulator; and
a photo detector to detect light output from the combiner and to output a time-varying intensity signal, I, to be analyzed for shifts in frequency in the time-varying intensity signal to measure electrophoretic mobility in the sample.

10. The apparatus of claim 9 further comprising at least one polarization maintaining fiber coupling any of the laser, the splitter, the modulators, the attenuator, the sample cell, and the combiner together.

11. The apparatus of claim 9 wherein any of the splitter, the modulators, the attenuator, and the combiner are fused together.

12. The apparatus of claim 9 wherein the splitter comprises a split ratio wherein a majority of the laser light is directed to the sample cell.

13. An apparatus comprising:
a long coherence length laser;
a fiber splitter optically coupled to the laser;
a reference arm polarization maintaining acousto-optic modulator optically coupled to a reference arm output of the splitter;
a polarization maintaining attenuator optically coupled to an output of the reference arm modulator;
a sample arm polarization maintaining acousto-optic modulator optically coupled to a sample arm output of the splitter;
a sample cell to contain a sample and optically coupled to the output of the sample arm modulator;
a polarization maintaining combiner optically coupled to an output of the attenuator and to an output of the sample cell; and
a photo detector to detect light output from the combiner and to output a time-varying intensity signal, I, to be analyzed for shifts in frequency in the time-varying intensity signal to measure electrophoretic mobility in the sample.

14. The apparatus of claim 13 further comprising at least one polarization maintaining fiber coupling any of the laser, the splitter, the modulators, the attenuator, the sample cell, and the combiner together.

15. The apparatus of claim 13 wherein any of the splitter, the modulators, the attenuator, and the combiner are fused together.

16. The apparatus of claim 13 wherein the splitter comprises a split ratio wherein a majority of the laser light is directed to the sample cell.
